(19) United States
(12) Patent Application Publication
(10) Pub. No.: US 2005/0086249 A1
(43) Pub. Date: Apr. 21, 2005

(54) Method for logical volume conversions

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/688,222

(22) Filed: Oct. 16, 2003

(51) Int. Cl. G06F 17/00

(52) U.S. Cl. 707/102

(57) ABSTRACT

A logical volume is converted from a first format on a first physical volume to a second format on a second physical volume while the logical volume remains available to applications and users. The online conversion is made possible by allowing a temporary mirroring of the existing physical volume(s) with the new physical volumes, using different characteristics on the two physical volumes.

### BACKGROUND OF THE INVENTION

1. Technical Field

The invention relates generally to the handling of logical volumes by the logical volume manager. More specifically, the invention relates to converting a logical volume from a first format on a first physical volume to a different format on a second physical volume.

2. Description of Related Art

UNIX-based operating systems utilize the concepts of physical volumes and logical volumes in handling disk storage. These concepts need to be understood in order to understand the invention.

Physical Volumes

FIGS. 1A and 1B demonstrate several aspects of a disk drive or physical volume. Looking first at FIG. 1A, physical volume 100 is composed of a number of platters 110, 112, and 114. Platters 110, 112, and 114 are stacked on a spindle 116, with space between the platters. Each one of platters 110, 112, and 114 has both an upper and a lower writing surface; each writing surface has a metallic coating that stores data by changing the polarity of tiny magnetized zones retained in the metallic coating of the platter. Read/write head 120, which rides just above the surface of platter 110, sets the polarity of the coating. Read/write head 120 is constructed so that when a current is passed through this element, head 120 can polarize the magnetized zones in the metallic coating under read/write head 120; when there is no current through this element, read/write head 120 will sense the polarity of the magnetized zones. A separate read/write head, such as read/write head 120, is provided for both sides of platters 110, 112, and 114, although only read/write heads 120 for the lower surfaces of each platter 110, 112, 114 are shown here. The heads are collectively mounted on arm 130 and driven by actuator 132 such that all read/write heads 120 move together from the outer rim of the platters toward the center and back. In the example shown, with three platters, platters 110, 112, and 114, there are a total of six heads (three are shown), but only one head can be active at any given time.

Each one of platters 110, 112, 114 is divided into tracks 140, which are arranged in concentric bands on each platter, much like the annual rings on a tree. Looking now at FIG. 1B, single track 140 is magnified in order to point out that track 140 is divided into sectors 150. Each of sectors 150 contains a fixed number, generally 512, of contiguous bytes. The sectors are numbered sequentially beginning from either the outer or inner track. Normally, the outer tracks contain more sectors than the inter tracks. In UNIX, the sectors are also referred to as blocks. A partition, often referred to as a physical partition (PP), is a sequential set of blocks contained within a single physical volume. The number of blocks in a partition, as well as the number of partitions in a given physical volume, is fixed when the physical volume is installed. Physical volumes can be grouped into physical volume groups, with every physical volume in a volume group having the same partition size.

Logical Volumes

We will turn now to logical storage and the terms used to describe logical storage. Many of these logical storage terms correspond to physical storage terms, but refer more to the abstract way we think about files, rather than to the physical reality of how they are stored. For instance, logical records are records defined in terms of the information they contain rather than physical attributes, such as size. The records are organized into logical volumes (files), which provide a simple contiguous view of data storage to the application or user, while hiding the more complex and possibly non-contiguous physical placement of data. Physically, a logical volume can only exist within a single volume group; the logical volume cannot be expanded into other volume groups. A logical volume, being a conception of a file, is not mirrored, although the logical volume may be stored on a physical volume that is comprised of mirrored disks.

In order to make a logical volume more portable, the logical volume is organized into logical partitions, which are the same size as the physical partitions of the disk onto which the logical volume is written. Each logical partition will map to one or more physical partitions, as shown in FIGS. 2A and 2B. FIG. 2A shows logical file 200, containing a number of partitions LP1, LP2, LP3, LPx. In this example, physical volume 210 is not mirrored and a logical volume manager has mapped each of logical partitions LP1, LP2, LP3, LPx to corresponding physical partitions PP1, PP2, PP3, etc. on physical volume 210. FIG. 2B demonstrates the same logical volume 200 mapped onto mirrored physical volume 210′, which consists of disk drives 202 and 204. In this instance, as each logical partition is mapped to physical volume 210′, the logical partition will be mapped to a location on disk 202 and an identical location on disk 204. There are many ways in which logical volume 200 can be written to a physical volume, but a logical volume manager handles the translation between logical volume and physical volume so that the user does not have to worry about the physical organization.

Stripes

Striping is one method of writing a logical volume across two or more physical volumes so that the speed of reading or writing to the logical volume can be increased. When a physical volume is striped, all the logical partitions are mapped to physical partitions on the given physical volumes in a round-robin fashion, as demonstrated in FIG. 3A. In this figure, logical volume 300 is striped, using three physical volumes PV1, PV2, PV3. Logical volume 300 is divided into logical partitions LP1, LP2, . . . LPx. Logical partition LP1 is mapped or written into physical partition PP1 of PV1; second logical partition LP2 is mapped to PP1 of PV2, logical partition LP3 is mapped to PP1 of PV3; fourth logical partition LP4 is mapped to PP2 of PV1. The allocation continues in a circular fashion, writing into each physical drive in turn. Because the first three partitions, LP1, LP2, and LP3, are written to different physical volumes, they can be written simultaneously, improving the speed of writing. Likewise, when this section of logical volume 300 is being read, all three logical partitions are read simultaneously and are reconstructed into the original order.

Additionally, at the time the physical volumes are created, each physical partition is divided into chunks, which can have a size of 4 KB, 8 KB, 16 KB, 32 KB, 64 KB, or 128 KB. The size of the chunks is called the stripe length, while the number of physical volumes used is referred to as the stripe width. The chunks within the partition are also accessed in round-robin fashion, as shown in FIG. 3A. In LP1, chunks 1.1, 1.2, 1.3 are shown; in LP2, chunks 2.1, 2.2, 2.3 are shown; in LP3, chunks 3.1, 3.2, 3.3 are shown. An application reading sequentially from this logical volume will receive these chunks in the order 1.1, 2.1, 3.1, 1.2, 2.2, 2.3, 3.1, 3.2, 3.3, courtesy of the logical volume manager.

Conversions of Physical Organization

The characteristics of a physical volume, such as the size of partitions and chunks, whether or not the physical volume is striped, and the length and width of the stripe, are set when the physical volume is created and cannot be changed. During the lifetime of a logical volume, it may be desirable to convert the logical volume to different characteristics, e.g., converting a non-striped volume to a striped volume or changing a fixed characteristic of a striped volume. Currently, to change these characteristics, the logical volume must first be taken offline from any applications that use the logical volume. Next, the file is copied from the current physical volume(s) to the new physical volume(s). When the copying is completed, the logical volume on the new physical volume is put back online for the application to use.

When it is necessary to convert a very active and/or very large logical volume, the conversion can cause a great deal of disruption to the programs and users who access the logical volume. It would be desirable to be able to convert the logical volume characteristics while the logical volume remains available to the applications.

### SUMMARY OF THE INVENTION

The invention presents a method, apparatus, and computer instructions in which a logical volume can be converted from a first format on a first physical volume to a second format on a second physical volume while the logical volume remains available to the applications and users who access the logical volume. The conversion while remaining online is made possible by allowing a temporary mirroring of the existing physical volume(s) with the physical volumes onto which the logical volume will be moved. During the synchronization of the two physical volumes, reads to the logical volume are directed only to the original physical volume, while writes are directed to both the original and the new physical volumes. Access by an application is blocked only to those portions of the logical volume that are currently being synchronized.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIGS. 1A and 1B demonstrate aspects of a disk drive or physical volume.

FIGS. 2A and 2B demonstrate how a logical file can be mapped to a physical volume, first without mirroring, then with mirroring.

FIGS. 3A and 3B demonstrate how a logical file can be mapped to a striped set of physical volumes.

FIG. 4 depicts a pictorial representation of a network of data processing systems in which the present invention may be implemented.

FIG. 5 depicts a block diagram of a data processing system that may be implemented as a server in accordance with a preferred embodiment of the present invention.

FIG. 6 depicts the relationship between the logical volume that is manipulated at the application level, the physical volume onto which the information is written, and the Logical Volume Manager.

FIGS. 7A and 7B depict flowcharts of the method used during conversion of the file. FIG. 7A depicts the mirroring process that copies the logical file and FIG. 7B depicts the handling of reads and writes from the application during the conversion.

FIG. 8 illustrates two striped physical volume groups that can be used in a conversion according to an exemplary embodiment of the invention.

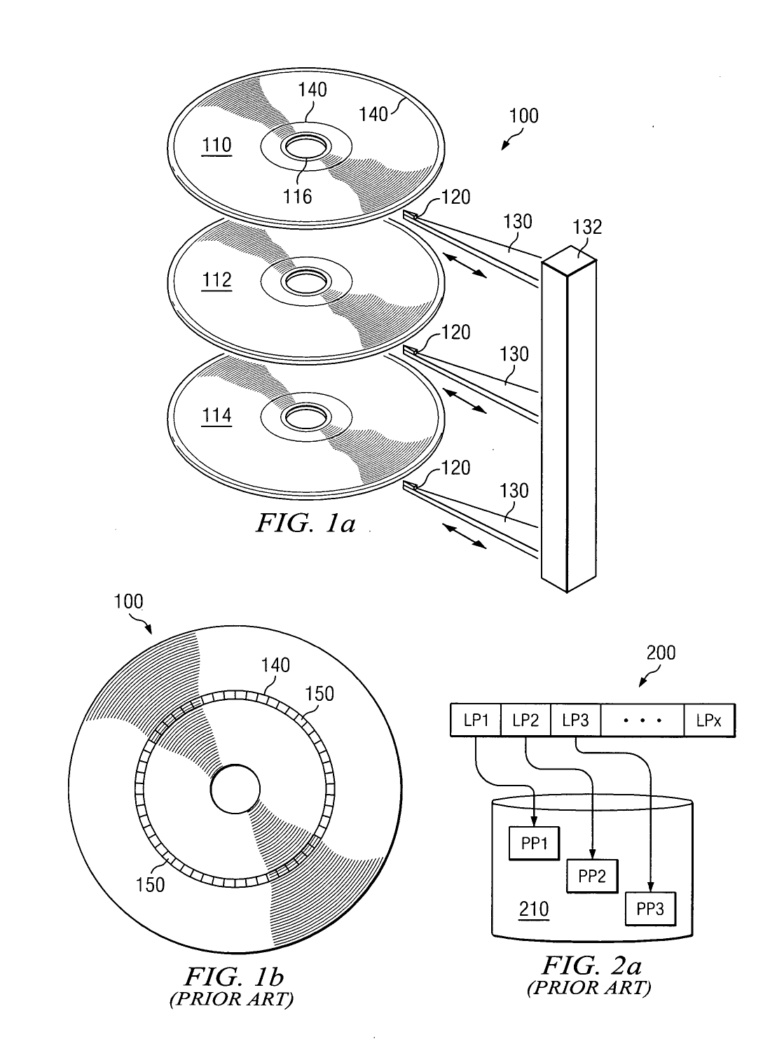

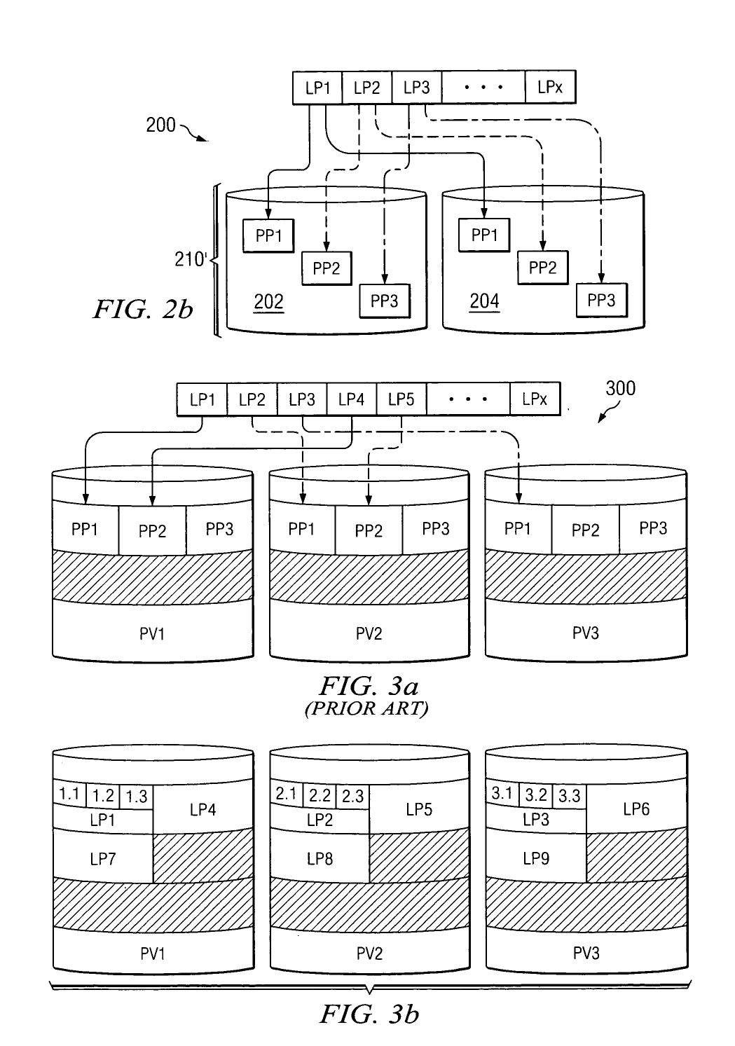

### DETAILED DESCRIPTION OF THE PREFERRED EMBODIMENT

As will be shown below, various embodiments of the invention allow a temporary mirror, with a first set of physical volumes having one set of characteristics, while the second set of physical volumes in the mirror have a different set of characteristics. The metadata for the logical volume is kept in memory during the time the mirror exists. This allows conversion, for example, of a striped logical volume from one set of characteristic to another by supporting different temporary stripe characteristic in a new mirror. It also allows conversion of a non-striped logical volume to a stripped logical volume.

This task is accomplished by creating a temporary LV entry point that represents the original physical volume characteristics and a temporary, hidden entry point that represents the new physical volume characteristics. One or more new, hidden physical volumes are allocated to represent the new hidden physical volume entry points and the original LV entry is modified in core such that it now has contiguous PPs on the two new hidden physical volumes.

Once the new mirror is created, the process of synchronizing the original logical volumes with its mirrors begins. Status changes from stale to fresh are only be kept in memory and not recorded on disk as there really aren't any disks to record this meta data on. All reads flow to the mirror containing the original logical volume characteristics. All writes to synchronized areas flow to both mirrors.

When all data has been synchronized, the in-core original LV is modified to use the new half of the mirror that has new logical volume characteristics, while the original half of the mirror is deleted.

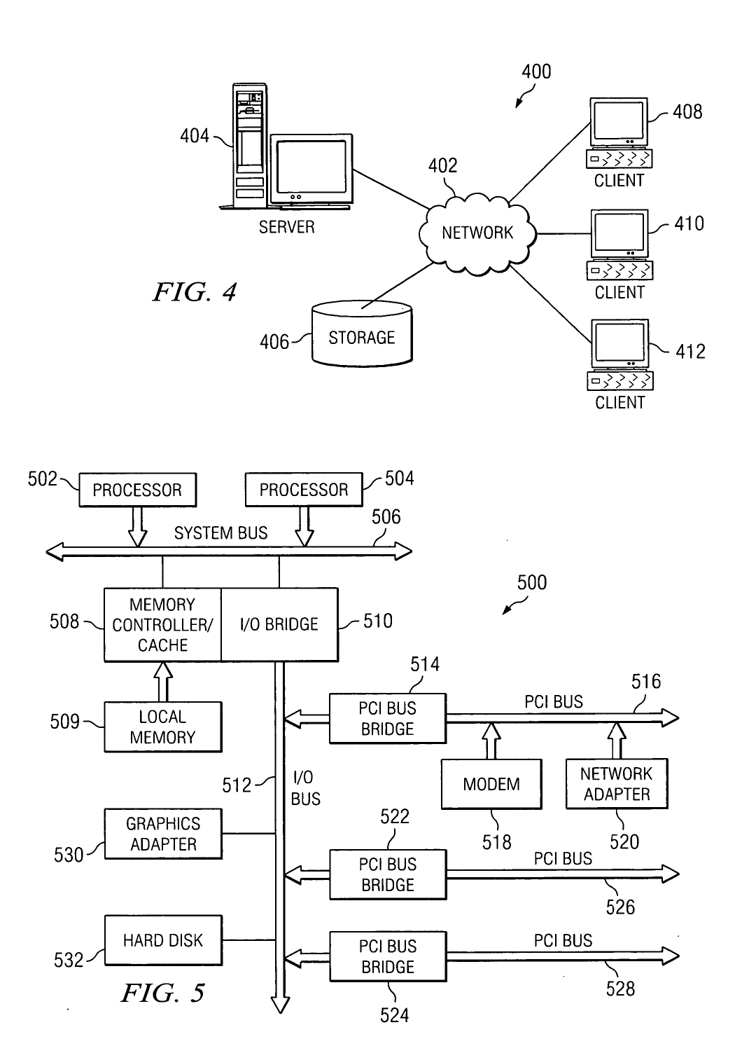

With reference now to the figures, FIG. 4 depicts a pictorial representation of a network of data processing systems in which the present invention may be implemented. Network data processing system 400 is a network of computers in which the present invention may be implemented. Network data processing system 400 contains a network 402, which is the medium used to provide communications links between various devices and computers connected together within network data processing system 400. Network 402 may include connections, such as wire, wireless communication links, or fiber optic cables.

In the depicted example, server 404 is connected to network 402 along with storage unit 406. In addition, clients 408, 410, and 412 are connected to network 402. These clients 408, 410, and 412 may be, for example, personal computers or network computers. In the depicted example, server 404 provides data, such as boot files, operating system images, and applications to clients 408-412. Clients 408, 410, and 412 are clients to server 404. Network data processing system 400 may include additional servers, clients, and other devices not shown. In the depicted example, network data processing system 400 is the Internet with network 402 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 400 also may be implemented as a number of different types of networks, such as for example, an intranet, a local area network (LAN), or a wide area network (WAN). FIG. 4 is intended as an example, and not as an architectural limitation for the present invention.

Referring to FIG. 5, a block diagram of a data processing system that may be implemented as a server, such as server 404 in FIG. 4, is depicted in accordance with a preferred embodiment of the present invention. Data processing system 500 may be a symmetric multiprocessor (SMP) system including a plurality of processors 502 and 504 connected to system bus 506. Alternatively, a single processor system may be employed. Also connected to system bus 506 is memory controller/cache 508, which provides an interface to local memory 509. I/O bus bridge 510 is connected to system bus 506 and provides an interface to I/O bus 512. Memory controller/cache 508 and I/O bus bridge 510 may be integrated as depicted.

Peripheral component interconnect (PCI) bus bridge 514 connected to I/O bus 512 provides an interface to PCI local bus 516. A number of modems may be connected to PCI local bus 516. Typical PCI bus implementations will support four PCI expansion slots or add-in connectors. Communications links to clients 408-412 in FIG. 4 may be provided through modem 518 and network adapter 520 connected to PCI local bus 516 through add-in boards.

Additional PCI bus bridges 522 and 524 provide interfaces for additional PCI local buses 526 and 528, from which additional modems or network adapters may be supported. In this manner, data processing system 500 allows connections to multiple network computers. A memory-mapped graphics adapter 530 and hard disk 532 may also be connected to I/O bus 512 as depicted, either directly or indirectly.

Those of ordinary skill in the art will appreciate that the hardware depicted in FIG. 5 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 5 may be, for example, an IBM eServer pSeries system, a product of International Business Machines Corporation in Armonk, N.Y., running the Advanced Interactive Executive (AIX) operating system or LINUX operating system.

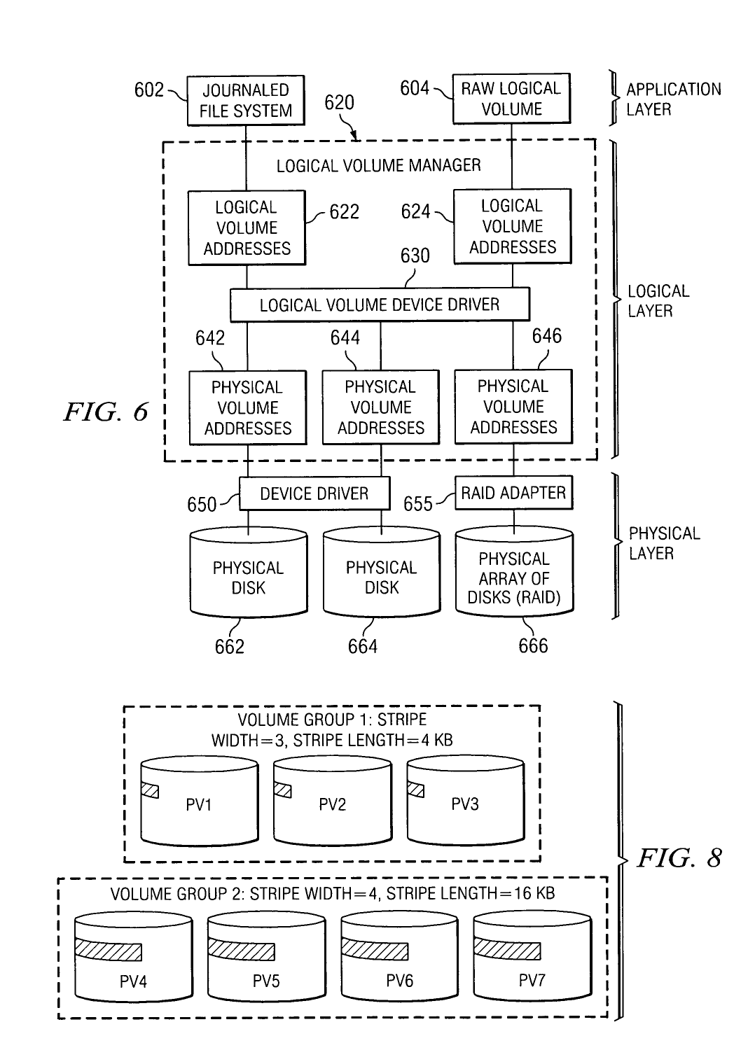

FIG. 6 illustrates the relationship between the application, the logical volume manager (which is part of the operating system), and the physical volumes. At the top level of the figure, the application works with both journaled file systems 602, which are volumes organized as a hierarchical structure of files and directories, and raw logical volumes 604, volumes not having the hierarchical structure. This is essentially a view that is very user-friendly, one that programmers can easily grasp and manipulate. At the bottom level of the figure are the actual physical disks, which can be individual physical volumes 662, 664, volume groups, or mirrored arrays 666, such as a Redundant Array of Inexpensive Disks (RAID), and their controllers 650, 655. Here, the coding is written with the view of physical spaces into which the logical volumes must be stored in a manner that allows them to be retrieved at will and in order. This view is not particularly user-friendly, but is a necessary part of maintaining flexibility in the logical volumes.

The Logical Volume Manager (LVM) 620 controls disk resources by mapping data between the simple and flexible logical view of storage space used by the application and the actual physical disks. The LVM does this by using a layer of device driver code, the logical device driver code 630, which runs above the traditional physical device drivers 650, 655. In other words, the LVM provides a “translation” from the logical view of the logical volumes 622, 624 to the physical view 642, 644, 646 and back, using a set of operating system commands, library subroutines, and other tools.

When a logical volume is to be converted from one format to another, space must be allocated on at least one new physical volume to receive the converted logical volume. If the new physical volume is to be striped, the space must be allocated on two or more physical volumes having the same characteristics. To simplify discussion, we shall refer to the logical volume as contained on the original physical volume(s) in the original format as PVA, while the new physical volume(s), which is formatted in the new format, will be referred to as PVB. Once PVB has been allocated with the desired characteristics, an entry point to PVB is created, but this entry point is hidden from the application, which only “sees” PVA. The entry point of PVA is changed in core memory to reflect the temporary mirroring. Synchronizing PVA to PVB then begins.

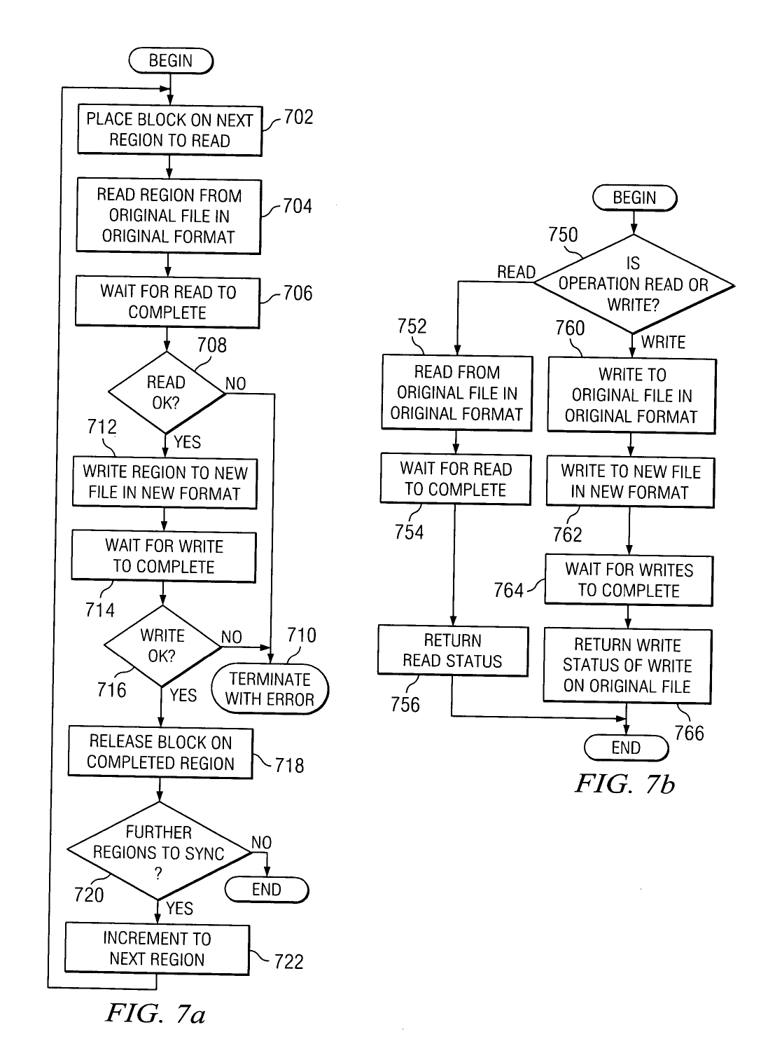

As seen in FIG. 7A, the process begins by placing a block on the region of the logical volume that is to be copied next (step 702), the region being designated by offset into the logical volume. The block prevents any applications from reading or writing to this region during the copy procedure, ensuring that the LVM can keep control of the contents of the logical volume. However, the block does not affect other regions of the volume, and the application is soon able to retry I/O to the given region. The process then reads a region from PVA (step 704). The size of the region being read will depend on the characteristics of both PVA and PVB. For example, assume that both PVA and PVB are striped, but the width of the stripe on PVB is greater than that of PVA, i.e., PVB uses more disks. Since the writes to all disks of PVB are simultaneous, it will be necessary to read enough partitions of PVA to fill at least one stripe on PVB. The LVM then waits for the read to be completed (step 706) and checks to be sure that the read completed normally (step 708). If there was a problem with the read, the process returns an error message and terminates (step 710).

If, however, the read is normal, the process will write the region to PVB, where the region will be stored in the new format (step 712). After issuing the write, the process waits for the write to complete (step 714) and checks the status of the write (step 716). If the write did not complete normally, the process terminates with an message (step 710). Note that at this point, PVB does not contain any stored metadata giving the status of the data. Therefore, it is important that any errors in the transfer of data be caught before PVB becomes the only physical volume, instead of a temporary mirror. Once the write is complete, the block can be removed from this region of PVA (step 718). The process checks to see if the entire volume has been copied to PVB (step 720). If further regions need to be copied, the process increments to the next region (step 724) and returns to the read step (step 704), repeating as necessary. If no further regions remain, the copy process is complete. The LVM then modifies the in-core indicators to reflect that the logical volume now resides on PVB and has the new characteristics (step 730). PVA can then be deleted (step 732) and the process terminates.

At the same time that the logical volume is being copied as in FIG. 7A, one or more applications still have access to the logical volume. FIG. 7B depicts how the LVM handles requests from the applications. The process begins when the Logical Volume Manager receives a request from an application. The first determination is whether the request is for a read or a write (step 750), since these will be handled differently. If the request is a read, the request is directed solely to PVA, where the logical volume is read in the original format (step 752). The LVM waits for the read to complete (step 754) and returns the information, along with a read status (step 756) and the process terminates. If the determination (step 750) is made that the request is a write, the LVM writes first to PVA in the original format (step 760) then writes to PVB in the new format (step 762). The process waits for the writes to complete (step 764), then returns the write status of the write to the original file (step 766) and terminates. Note that during this process, the application may attempt to read from or write to a region that is blocked by the synchronization between PVA and PVB. In this case, the read or write from the application will not be performed until the synchronization of this region is completed. This process is transparent to the application, which would only be aware of a slightly longer time for the operation to be performed.

### EXAMPLE

In a first example, illustrated in FIG. 8, a logical volume LV1 is stored on Volume Group 1 (VG1), which consists of three physical volumes PV1, PV2, PV3. Volume Group 1 is striped with a stripe length of 4 KB (kilobytes). Because logical volume LV1 is rapidly growing, the logical volume is being copied to Volume Group 2 (VG2), which consists of four volumes, volumes PV4, PV5, PV6, and PV7. Volume Group 2 is also striped, with a length of 16 KB. One read to VG1 encompasses a stripe size of 3×4 KB=12 KB. A single write to VG2 encompasses a stripe size of 4×16 KB=64 KB. Therefore it will be necessary to read six stripes of VG1 (6×12=72) in order to write one stripe of 64 KB to VG2. However, LV1 will remain online during the entire process, with applications experiencing only minor delays due to attempted accesses to regions currently being synchronized.

The same process can be used to change a non-striped file to a striped file or vice versa, as well as to change any fixed characteristic that needs to be changed.

The described method and system allows a logical volume to be converted to a different format while remaining online for use by applications even as the logical volume is being converted. Only the regions of the logical volume that are currently involved in the copy are temporarily blocked from use by applications.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of converting the characteristics under which a logical volume is stored on a first physical volume group, said method comprising the steps of:
allocating a second physical volume group having the desired characteristics for storing said logical volume;
setting up said second physical volume group as a temporary mirror of said first physical volume group, wherein:
reads of said logical volume from an application are directed solely to said first physical volume group and
write to said logical volume from an application are directed to both said first physical volume group and said second physical volume group; and
synchronizing said logical volume from said first physical volume group to said second physical volume group.

2. The method of claim 1, further comprising, during said synchronizing step, blocking access by an application to a portion of said logical volume whenever said portion is being synchronized.

3. The method of claim 1, further comprising, after completion of said synchronizing step, dropping said temporary mirroring and indicating said second physical volume group to be the location of said logical volume.

4. The method of claim 1, wherein at least one of said first physical volume group and said second physical volume group comprise a plurality of physical volumes.

5. The method of claim 1, wherein at least one of said first physical volume group and said second physical volume group is striped.

6. The method of claim 1, wherein at least one of said first physical volume group and said second physical volume group is not striped.

7. The method of claim 1, wherein both said first physical volume group and said second physical volume group are striped and a stripe characteristic is changed during said conversion.

8. A computer system, comprising:
a first processor connected as a server;
a plurality of client processors connected to said first processor;
a logical volume stored on a first physical volume group and connected to be accessed from said first processor and said plurality of client processors, said first physical volume having a first set of fixed characteristics;
a second physical volume group having a second set of fixed characteristics that are different from said first set of fixed characteristics;
first instructions for setting up said second physical volume group as a temporary mirror of said first physical volume group, wherein:
reads of said logical volume from an application are directed solely to said first physical volume group and
writes to said logical volume from an application are directed to both said first physical volume group and said second physical volume group; and
second instructions for synchronizing said logical volume from said first physical volume group to said second physical volume group.

9. The computer system of claim 8, further comprising, in said synchronizing step, third instructions for blocking access by an application to a portion of said logical volume whenever said portion is being synchronized.

10. The computer system of claim 8, further comprising fourth instruction for dropping said temporary mirroring and indicating said second physical volume group to be the location of said logical volume after completion of said synchronizing step.

11. The computer system of claim 8, further comprising fifth instructions for handling striping of said physical volume groups.

12. A computer program product on a computer readable medium, said computer program product comprising:
first instructions for setting up a first physical volume group having a first set of fixed characteristics as a temporary mirror to a second physical volume group having a different set f fixed characteristics, said second volume group containing a logical volume, wherein:
reads of said logical volume from an application are directed solely to said second physical volume group and
write to said logical volume from an application are directed to both said first physical volume group and said second physical volume group; and
second instructions for synchronizing said logical volume from said second physical volume group to said first physical volume group.

13. The computer program product of claim 12, further comprising third instructions for blocking, during said synchronizing step, access by an application to a portion of said logical volume whenever said portion is being synchronized.

14. The computer program product of claim 12, further comprising fourth instructions for dropping said temporary mirroring and indicating said second physical volume group to be the location of said logical volume after completion of said synchronizing step.
